(19) United States
(12) Patent Application Publication
(10) Pub. No.: US 2004/0050055 A1
(43) Pub. Date: Mar. 18, 2004

(54) Gas turbine power augmenting spray nozzle assembly

(75) Inventors: Daniel A. Vidusek, Hampshire, IL (US); Matthew J. Roman, St. Charles, IL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: Spraying Systems, Co., Wheaton, IL

(21) Appl. No.: 10/243,043

(22) Filed: Sep. 13, 2002

(51) Int. Cl. F02C 3/30

(52) U.S. Cl. 60/728; 60/39.53

(57) ABSTRACT

A power augmenting spray nozzle assembly for directing a fine liquid spray into an air inlet of a gas turbine. The nozzle assembly includes a nozzle body, and an orifice member supported within the body and having an upstream whirl chamber and a downstream discharge orifice for directing liquid into a predetermined conical spray pattern. The orifice member is made of a corundum, preferably a synthetic ruby or sapphire material, having surfaces of a hardness of 9 MOHS such that the discharge orifice is effective for discharging a fine liquid spray with substantially uniform, fine liquid particles.

### FIELD OF THE INVENTION

The present invention relates generally to liquid spray nozzles, and more particularly, to spray nozzle assemblies particularly adapted for directing a fine water spray into the inlet air streams of gas powered turbines for enhanced power output.

### BACKGROUND OF THE INVENTION

Gas fired turbines typically draw an air stream through a series of compressor stages that compress the air. The compressed air is directed into a combustion chamber and heated, and the rapidly expanding heated gases drive turbine blades that generate power. To enhance output power, it is known to spray fine water particles into the inlet air stream which cools the air to increase its density, and hence, enables increased subsequent gas expansion for driving the turbine blades.

Heretofore, existing liquid spray systems for gas turbines have been subject to a variety of design and operational problems. While it is desirable that the water spray introduced into the inlet air stream have substantially uniform small liquid particles, it has been difficult and expensive to manufacture spray nozzles which will reliably produce such spray patterns. Indeed, the discharge orifice of such nozzles must be on the order of 0.01 inch in diameter, and imperfections in the machined surfaces that define the discharge orifice can create undesirable streaking in the discharging liquid spray pattern, i.e., substantially larger, unequal liquid particles in portions of the spray pattern. Costly lapping and polishing of the machined surfaces for eliminating such surface imperfections tend to round the downstream edge or corner of the discharge orifice, which further deteriorates the desired spray performance. Since it is common to use deionized and de-chemicalized water during such spraying, over time, chemical reactions can further adversely affect metal orifice defining surfaces and the resulting liquid spray distribution. Moreover, even metal orifice defining members can be subject to extensive wear and require costly periodic replacement.

### OBJECTS AND SUMMARY OF THE INVENTION

It is an object of the present invention to provide an improved spray nozzle assembly adapted for producing a discharging spray pattern of fine fog-like liquid particles within a narrow size spectrum.

Another object is to provide a spray nozzle assembly as characterized which is operable for more effectively enhancing the output power of gas turbines.

A further object is to provide a spray nozzle assembly of the foregoing type which is designed for discharging a hollow cone spray pattern and in which the discharge orifice has enhanced surface and edge characteristics.

Yet another object is to provide a spray nozzle assembly of the above kind which can be used over prolonged periods without deterioration of the discharge orifice-defining surfaces or edges.

Still a further object is to provide a spray nozzle assembly of the foregoing type which has an orifice-defining member or tip that is chemically inert to deionized or de-chemicalized liquids directed through the nozzle assembly during spraying.

Another object is to provide such a spray nozzle assembly in which the orifice defining member or tip is made of a hard material that resists wear, and hence, minimizes the necessity for replacement.

Still another object is to provide a spray nozzle assembly of the foregoing type which is adapted for economical manufacture and long term reliable usage.

Other objects and advantages of the invention will become apparent upon reading the following detailed description and upon reference to the drawings, in which:

### BRIEF DESCRIPTION OF THE DRAWINGS

FIG. 1 is a diagrammatic depiction of a gas-fired turbine having a power augmenting liquid spray system with spray nozzle assemblies in accordance with the present invention;

FIG. 2 is an enlarged longitudinal section of one of the illustrated spray nozzle assemblies, taken in the plane of line 2-2 in FIG. 1;

FIG. 3 is an enlarged longitudinal section of the illustrated spray nozzle assembly, taken in the plane of line 3-3 in FIG. 2;

FIG. 4 is a fragmentary transverse section of the illustrated spray nozzle assembly, taken in the plane of line 4-4 in FIG. 3;

FIG. 5 is an enlarged longitudinal section of an orifice defining insert member of the illustrated spray nozzle assembly; and

FIG. 6 is an upstream end view of the illustrated orifice defining insert member, taken in the plane of line 6-6 in FIG. 5.

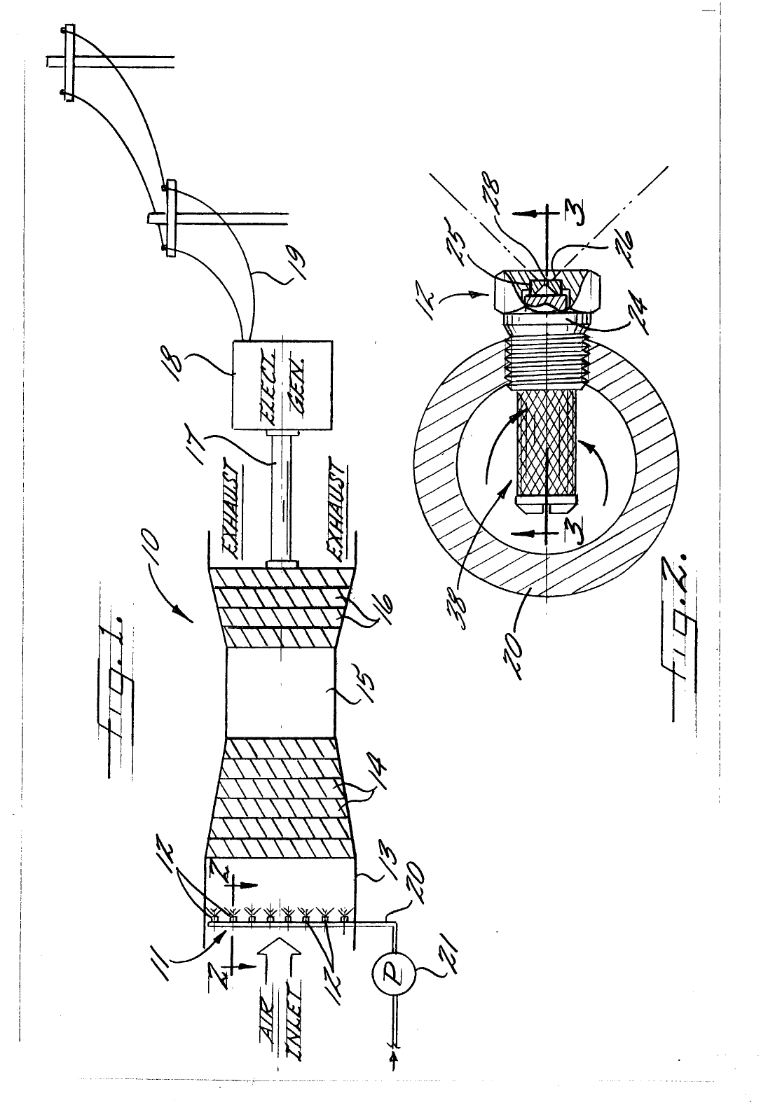

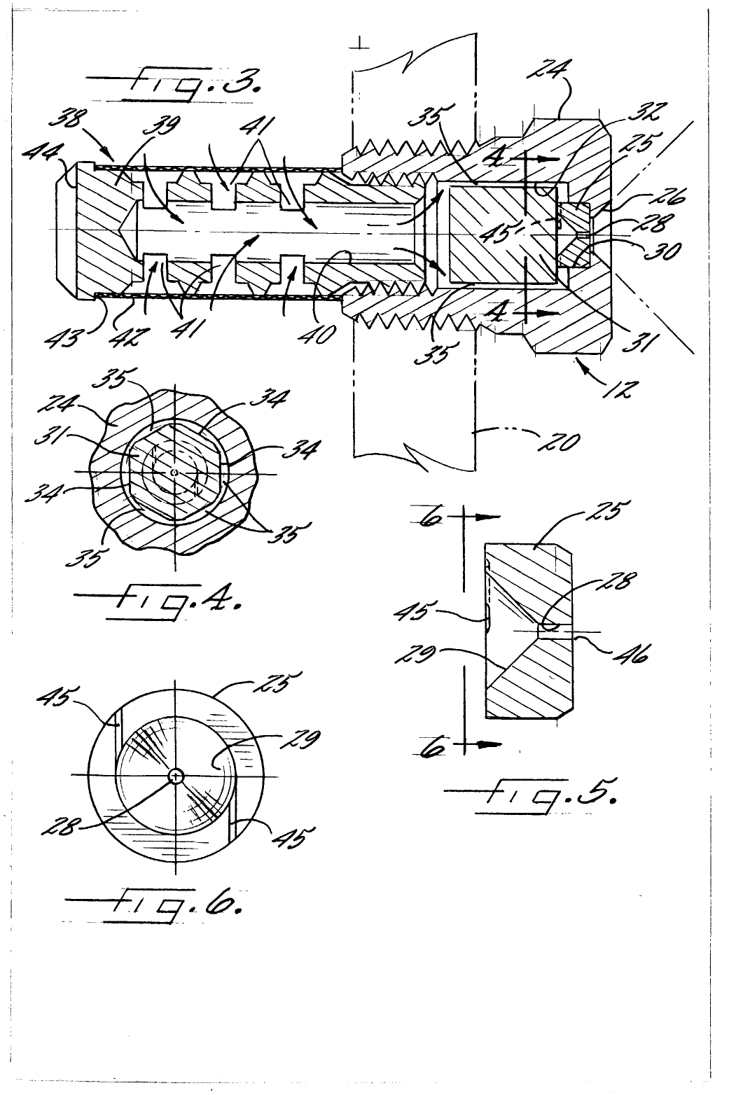

While the invention is susceptible of various modifications and alternative constructions, a certain illustrative embodiment thereof has been shown in the drawings and will be described below in detail. It should be understood, however, that there is no intention to limit the invention to the specific form disclosed, but on the contrary, the intention is to cover all modifications, alternative constructions, and equivalents falling within the spirit and scope of the invention.

### DETAILED DESCRIPTION OF THE PREFERRED EMBODIMENT

Referring now more particularly to the drawings, there is shown an illustrative gas turbine 10 which includes a power augmenting liquid spray system 11 having a plurality of spray nozzle assemblies 12 in accordance with the invention disposed at an air inlet end 13 of the turbine 10. The illustrative gas turbine 10, which is of a known type, draws air into the inlet end 13 by means of an appropriate fan. The inlet air is compressed in a series of compressor stages 14 to pressures typically up to 40 times higher than atmospheric conditions. Following this, the highly compressed air enters a combustion chamber 15 where fuel is mixed with the air and burned. The burning fuel causes rapid expansion of gases within the combustion chamber 15, which rotatably drives downstream turbine blades 16, an output shaft 17 and an electrical generator 18 which generates power, that in this case is supplied to power lines 19. It should be understood that while the spraying system 11 of the present invention is illustrated for use with a gas turbine, the spray nozzles assemblies 12 may have utility in connection with other types of turbines and in connection with other uses in which it is desired to spray a fog of fine liquid particles within a narrow spectrum of sizes.

To enhance gas expansion in the combustion chamber, and hence, augment output power of the turbine, the spray nozzle assemblies 12 are adapted for discharging sprays of fine fog-like liquid particles into the air stream entering the turbine 10. The illustrated nozzles 12 are mounted on a common header or supply pipe 20 into which a liquid, preferably deionized water, is directed by a pump 21. It will be understood that while the illustrated spraying system 11 includes a plurality of spray nozzle assemblies 12, in some applications in which lesser amounts of liquid are required, a single spray nozzle assembly 12 may be employed. Since the nozzle assemblies 12 are identical in construction, only one need be described in detail.

Each spray nozzle assembly 12 comprises an elongated hollow nozzle body 24 that supports and holds a generally cylindrically configured orifice-defining insert member 25 adjacent an outwardly flared conical opening 26 in a downstream end of the nozzle body 24. The orifice defining insert member 25 defines an elongated liquid discharge orifice 28 in axial alignment with the nozzle body opening 26 and an upstream, inwardly tapered conical whirl chamber 29 communicating with the discharge orifice 28. The orifice insert member 25 is supported within a counter bore 30 in the nozzle body 24 and is retained therein by a back-up member 31 which is supported within an enlarged diameter cylindrical bore 32 of the nozzle body 24 and is forced against the insert member 25 by pressurized liquid directed through the nozzle assembly 12. The back-up member 31 in this instance has a hex-shaped cross section and is supported within the bore 32 such that flat surfaces 34 of the back-up member 31 and the cylindrical bore 32 of the nozzle body define a plurality of circumferentially spaced, longitudinal liquid flow passages 35 communicating between an upstream inlet end of the nozzle body 24 and the orifice member 25.

For straining liquid entering the nozzle assembly 12, a strainer subassembly 38 is mounted on an upstream end of the nozzle body 24. The strainer subassembly 38 includes an elongated strainer support 39 which is threadedly supported within an upstream end of the nozzle body 24 and is formed with a axial flow passage 40 communicating with the nozzle body inlet end and a plurality of radial flow passages 41 communicating with the axial passage 32. The strainer support 39 carries a cylindrical strainer screen 42 interposed between an upstream end of the nozzle body 24 and a shoulder 43 of the support 39. The support 39 in this case has a diagonal slot 44 in an upstream end to facilitate screwing of the support 39 into engagement with the nozzle body 24. It will be seen that liquid directed through the header 20 will communicate through the screen 42, the radial and axial passages 41, 40 of the support 39 into the nozzle body 24, and through the longitudinal passages 35 about the back-up member 31 to the orifice defining insert member 25.

For generating a hollow cone discharge spray pattern, the upstream end of the orifice-defining insert member 25 is formed with a pair of diametrically opposed cross slots 45, which together with the downstream end of the back-up member 31 defines a pair of opposed tangential passages for directing liquid from the longitudinal passages 35 tangentially into the conical whirl chamber 29 in a swirling fashion. The swirling liquid in turn communicates through the discharge orifice 28 and out of the spray nozzle assembly 12 in a hollow cone spray pattern. As indicated previously, while it is desirable that the spray pattern be in the form of fine fog-like liquid particles in a narrow size spectrum, heretofore imperfections in the surface of the discharge orifice and the sharpness of the downstream corner or annular edge 46 of the discharge orifice 28 can create undesirable streaking in the discharging spray. Prior orifice-defining members, furthermore, have been susceptible to excessive wear which can further deteriorated spray performance and necessitated periodic replacement.

In accordance with the invention, the orifice-defining member is made of a corundum material having a hardness of about 9 MOHS, and the discharge orifice is defined by precision surfaces and edges such that the discharging hollow cone spray pattern has fine liquid particles within a narrow spectrum of sizes. Preferably, the orifice member is made of a synthetic corundum, typically synthetic sapphire or ruby, which has a surface hardness of 9 MOHS and which permits precision formation of the discharge orifice and resists wear and chemical degradation. Synthetic sapphire and ruby gemstones of such type, which are commercially available, have a hardness of 9 MOHS. One commercially available synthetic sapphire has the following further properties.

| | |
|---|---|
| Chemical Composition | Al₂0₃ |
| Physical properties | |
| Crystal structure | Hexagonal rhombohedral |
| Specific gravity | 3.99 ÷ 3.98 |
| Thermal properties | |
| Melting point | 2050° C. |
| Thermal expansion | 5.4 − 10⁶/° C. face perp. C axis |
| | 6.2 − 10⁶/° C. face parall. C axis |
| Mechanical properties | |
| Hardness mohs | 9 |
| knoop | 1800 face perp. C axis |
| | 2200 face parall. C axis |
| Modulus of elasticity | 4.4 × 10⁶ kg/cm²/ ± 1% young |
| | E. |
| Chemical properties | |
| Acids and alkalis attack | 0 at 300° C. |
| Porosity | 0 |
| Electrical properties | |
| Dielectric constant | 9.4 at 11.3 |
| Electrical resistance | 10¹¹ ohm/cm at 500° C. |
| | 10⁶ ohm/cm at 1000° C. |
| | 10³ ohm/cm at 2000° C. |

The cylindrical discharge orifice 28 may be formed with precision smoothness and a sharp corner or edge 46 at the downstream end which facilitates the generation and direction of a fine liquid particle spray pattern without undesirable streaking, typical of conventional machined metal orifice defining members.

It will be appreciated by one skilled in the art that unlike synthetic diamond gemstones, sapphire and ruby gemstones can be economically processed and manufactured with precision surfaces and edges by economical, known processing techniques. Such gemstones, furthermore, are free from acidic and alkali attack at temperatures up to 300° C. and have a porosity of 0. It has been unexpectedly found that orifice members manufactured by such gemstones may be formed with discharge orifices, on the order of 0.01 inch, with substantially imperfection-free surfaces and edge characteristics for enhanced fine liquid particle discharge. Spray nozzles with such orifice members are effective for discharging a consistent fine liquid spray. Indeed, the spray nozzle assemblies of the present invention have particular utility for directing liquid sprays into the inlet air streams of gas fired turbines for enhanced power augmentation. The sapphire and ruby gemstone material further is resistant to chemical attack from deionized water used in such gas turbine liquid spray systems and is substantially more resistant to wear than metal.

From the foregoing, it can be seen that the spray nozzle assembly of the present invention is adapted for producing a fine fog-like hollow cone liquid spray pattern with a narrow sized spectrum of liquid particles for more effectively enhancing the output power of gas turbines. The orifice defining insert members, furthermore, are adapted for prolonged usage without deterioration of the discharge orifice-defining surfaces and edges which reduces the necessity for replacement.

What is claimed is:

1. A spray nozzle assembly comprising:
a nozzle body having a liquid inlet for connection to a pressurized liquid supply,
an orifice member supported within said body, said orifice member defining a discharge orifice through which pressurized liquid supplied to said nozzle body is directed and from which liquid discharges in a predetermined spray pattern, and said orifice member being made of a corundum.

2. The spray nozzle assembly of claim 1 in which said orifice member is made of a synthetic ruby material.

3. The spray nozzle assembly of claim 1 in which said orifice member is made of a synthetic sapphire material.

4. The spray nozzle assembly of claim 1 in which said orifice member has a surface hardness of 9 MOHS.

5. The spray nozzle assembly of claim 1 in which said orifice member has a generally cylindrical configuration with upstream and downstream sides, said orifice member being formed with said discharge orifice adjacent to and communicating through said downstream side and a whirl chamber communicating between said upstream side and said discharge orifice whereby liquid supplied to said nozzle body and tangentially directed into said whirl chamber discharges from said discharge orifice in a hollow cone liquid spray pattern.

6. The spray nozzle assembly of claim 5 in which said orifice member is formed with passages which tangentially communicate with said whirl chamber for imparting a whirling movement to liquid directed into the whirl chamber.

7. The spray nozzle assembly of claim 2 in which said discharge orifice has a diameter of about 0.01 inches.

8. The spray nozzle assembly of claim 3 in which said nozzle body has an outwardly flared opening in a discharge end thereof through which liquid discharging from said discharge orifice is directed.

9. A power augmenting spray nozzle assembly for directing a fine liquid spray into an inlet air stream of a turbine comprising:
at least one spray nozzle, said spray nozzle having a body with a liquid inlet for connection to a pressurized liquid supply,
an orifice member supported within said body, said orifice member having a generally cylindrical configuration with upstream and downstream sides, said orifice member being formed with said discharge orifice adjacent to and communicating through said downstream side and a whirl chamber communicating between said upstream side and said discharge orifice whereby liquid supplied to said nozzle body and tangentially directed into said whirl chamber discharges from said discharge orifice in a hollow cone liquid spray pattern, and
said orifice member being made of a non-diamond synthetic material having a surface hardness of 9 MOHS.

10. The spray nozzle assembly of claim 9 in which said orifice member is made of a synthetic ruby material.

11. The spray nozzle assembly of claim 9 in which said orifice member is made of a synthetic sapphire material.

12. A gas turbine comprising a compressor stage into which air stream is directed from an air inlet and compressed, a combustion chamber into which fuel is directed for heating air compressed in such compression stage to expand said air, a turbine stage driven by said heated expanding air, a power augmenting spraying system for directing fine liquid particles into the air stream entering the compression stage from said air inlet, said spraying system including at least one liquid spray nozzle, said spray nozzle having a nozzle body having a liquid inlet for connection to a pressurized liquid supply, an orifice member supported within said body, said orifice member defining a discharge orifice through which pressurized liquid supplied to said nozzle body is directed and from which liquid discharges in a predetermined spray pattern, and said orifice member being made of a corundum and having a surface hardness of 9 MOHS.

13. The gas turbine of claim 12 in which said orifice member has upstream and downstream sides, and said orifice member being formed with said discharge orifice adjacent to and communicating through said downstream side and a whirl chamber communicating between said upstream side and said discharge orifice whereby liquid supplied to said nozzle body and tangentially directed into said whirl chamber discharges from said discharge orifice in a hollow cone liquid spray pattern.

14. The gas turbine of claim 12 in which said spraying system includes a plurality of said spray nozzle assemblies.
